(19) United States
(12) Patent Application Publication
(10) Pub. No.: US 2005/0258671 A1
(43) Pub. Date: Nov. 24, 2005

(54) Chair with a backrest pivotable relative to a support frame for concurrent actuation of a seat member and a leg rest

(76) Inventor: Chuen-Jong Tseng, Chiayi Hsien (TW)

Correspondence Address: LADAS & PARRY LLP, 224 SOUTH MICHIGAN AVENUE, SUITE 1600, CHICAGO, IL, 60604, US

(21) Appl. No.: 10/852,745

(22) Filed: May 24, 2004

(51) Int. Cl. A47C 1/02; A61G 15/00; A47C 7/02

(52) U.S. Cl. 297/89

(57) ABSTRACT

A chair includes a frame, a backrest, a seat member, and a leg rest. The backrest is coupled pivotally to the frame. The seat member is coupled pivotally to the backrest. The leg rest is coupled pivotally to the seat member. The backrest is pivotable relative to the support frame to a seating position, where the backrest and the seat member cooperatively define a first angle therebetween, and where the seat member and the leg rest cooperatively define a second angle therebetween. The backrest is further pivotable relative to the support frame to a reclining position, where the first and second angles are widened.

### BACKGROUND OF THE INVENTION

1. Field of the Invention

The invention relates to a chair, more particularly to a chair with a backrest that is pivotable relative to a support frame for concurrent actuation of a seat member and a leg rest.

2. Description of the Related Art

A conventional chair includes a support frame, a backrest, a seat member, a sliding mechanism, a leg rest, and a coupling unit. The backrest is coupled pivotally to the support frame. The seat member is coupled pivotally to the backrest. The sliding mechanism is coupled between the seat member and the support frame, and includes a tongue-and-groove arrangement that permits sliding movement of the seat member at any arbitrary position along the support frame. The legrest is coupled pivotally to the seat member. The coupling unit is coupled pivotally to the backrest and the leg rest.

From the above description, by manually operating the sliding mechanism, the backrest and the leg rest can be actuated synchronously to form any desired angle with the seat member.

While the aforementioned conventional chair achieves its intended purpose, since the tongue-and-groove arrangement requires a user to use both hands in operating the sliding mechanism, this causes inconvenience on the part of the user.

### SUMMARY OF THE INVENTION

Therefore, the object of the present invention is to provide a chair with a backrest that is pivotable relative to a support frame for concurrent actuation of a seat member and a leg rest.

According to the present invention, a chair includes a support frame, a backrest, a seat member, a connecting unit, a leg rest, and a coupling unit. The backrest has opposite first and second end portions, and a middle portion disposed between the first and second end portions of the backrest and coupled pivotally to the support frame. The seat member has opposite first and second ends. The first end of the seat member is coupled pivotally to the backrest at a position between the middle portion and the second end portion of the backrest. The connecting unit has a first pivot end coupled pivotally to the seat member at a position between the first and second ends of the seat member, and a second pivot end opposite to the first pivot end of the connecting unit and coupled pivotally to the support frame. The leg rest has opposite first and second ends. The first end of the leg rest is coupled pivotally to the second end of the seat member. The coupling unit has a first pivot end coupled pivotally to the second end portion of the backrest, and a second pivot end opposite to the first pivot end of the coupling unit and coupled pivotally to the leg rest at a position between the first and second ends of the leg rest. The backrest is pivotable relative to the support frame to a seating position, where the backrest and the seat member cooperatively define a first angle therebetween, and where the seat member and the leg rest cooperatively define a second angle therebetween. The backrest is further pivotable relative to the support frame to a reclining position, where the first and second angles are widened.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a chair according to the present invention;

FIG. 2 is a schematic view of the preferred embodiment in a seating position;

FIG. 3 is a schematic view of the preferred embodiment in a reclining position;

FIG. 4 is a schematic view of the preferred embodiment when applied as a swing; and

FIG. 5 is a schematic side view of FIG. 4.

### DETAILED DESCRIPTION OF THE PREFERRED EMBODIMENT

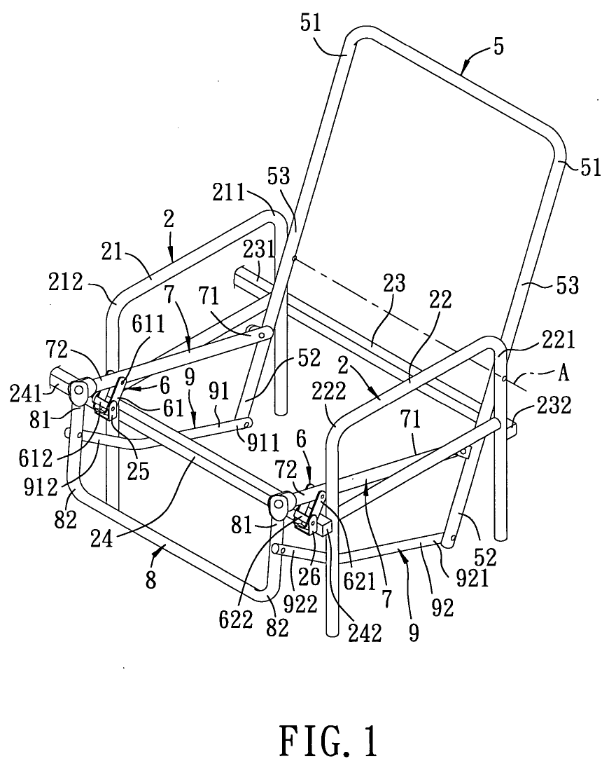

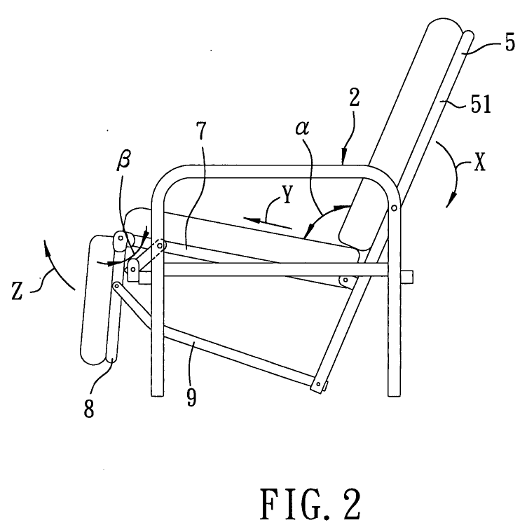

Referring to FIGS. 1 to 3, the preferred embodiment of a chair according to this invention is shown to include a support frame 2, a backrest 5, a seat member 7, a connecting unit 6, a leg rest 8, and a coupling unit 9.

The support frame 2 includes first and second armrests 21, 22 that are spaced apart from each other in a first direction. Each of the first and second armrests 21, 22 has a first end 211, 221, and a second end 212, 222 opposite to the first end 211, 221 of a respective one of the first and second armrests 21, 22 in a second direction transverse to the first direction.

The support frame 2 further includes a first horizontal bar 23 that has first and second end portions 231, 232 connected respectively to the first ends 211, 221 of the first and second armrests 21, 22, and a second horizontal bar 24 that has first and second end portions 241, 242 connected respectively to the second ends 212, 222 of the first and second armrests 21, 22.

The support frame 2 further includes first and second brackets 25, 26, each of which is mounted on a respective one of the first and second end portions 241, 242 of the second horizontal bar 24 of the support frame 2. In this embodiment, the first and second brackets 25, 26 are generally U-shaped.

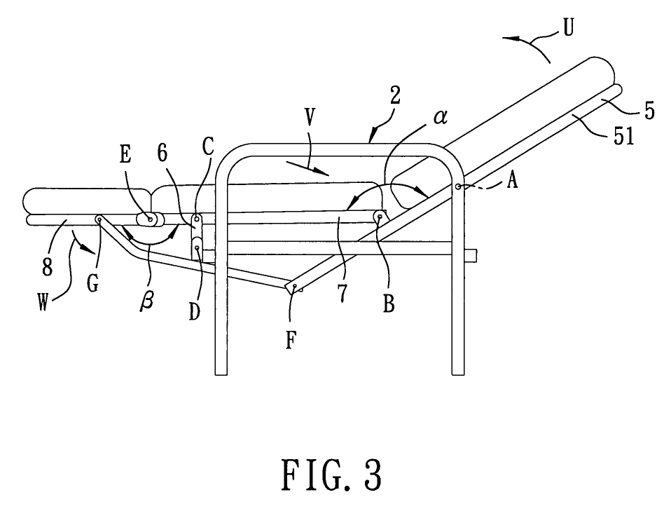

The backrest 5 has first and second end portions 51, 52, and a middle portion 53 disposed between the first and second end portions 51, 52 of the backrest 5. In this embodiment, the middle portion 53 of the backrest is coupled pivotally to the first ends 211, 221 of the first and second armrests 21, 22 of the support frame 2. As best shown in FIG. 3, the backrest 5 is pivotable relative to the support frame 2 about a first axis (A).

The seat member 7 has opposite first and second ends 71, 72. The first end 71 of the seat member 7 is coupled pivotally to the backrest 5 at a position between the middle portion 53 and the second end portion 52 of the backrest 5. As best shown in FIG. 3, the seat member 7 is pivotable relative to the backrest 5 about a second axis (B).

The connecting unit 6 includes first and second connectors 61, 62. Each of the first and second connectors 61, 62 has a first pivot end 611, 621, and a second pivot end 612, 622 opposite to the first pivot end 611, 621 of a respective one of the first and second connectors 61, 62. The first pivot end 611 of the first connector 61 of the connecting unit 6 is coupled pivotally to the seat member 7 at a position between the first and second ends 71, 72 of the seat member 7, whereas the second pivot end 612 of the first connector 61 of the connecting unit 6 is coupled pivotally to the first bracket 25 of the support frame 2. Similarly, the first pivot end 621 of the second connector 62 of the connecting unit 6 is coupled pivotally to the seat member 7 at a position between the first and second ends 71, 72 of the seat member 7, whereas the second pivot end 622 of the second connector 62 of the connecting unit 6 is coupled pivotally to the second bracket 26 of the support frame 2. In this embodiment, the first and second connectors 61, 62 of the connecting unit 6 are generally U-shaped. As best shown in FIG. 3, the connecting unit 6 is pivotable relative to the seat member 7 and the support frame 2 about third and fourth axes (C, D), respectively.

The leg rest 8 has opposite first and second ends 81, 82. The first end 81 of the leg rest 8 is coupled pivotally to the second end 72 of the seat member 7. As best shown in FIG. 3, the leg rest 8 is pivotable relative to the seat member 7 about a fifth axis (E).

The coupling unit 9 includes first and second couplers 91, 92. Each of the first and second couplers 91, 92 has a first pivot end 911, 921, and a second pivot end 912, 922 opposite to the first pivot end 911, 921 of a respective one of the first and second couplers 91, 92. The first pivot end 911 of the first coupler 91 of the coupling unit 9 is coupled pivotally to the second end portion 52 of the backrest 5, whereas the second pivot end 912 of the first coupler 91 of the coupling unit 9 is coupled pivotally to the leg rest 8 at a position between the first and second ends 81, 82 of the leg rest 8. Similarly, the first pivot end 921 of the second coupler 92 of the coupling unit 9 is coupled pivotally to the second end portion 52 of the backrest 5, whereas the second pivot end 922 of the second coupler 92 of the coupling unit 9 is coupled pivotally to the leg rest 8 at a position between the first and second ends 81, 82 of the leg rest 8. As best shown in FIG. 3, the coupling unit 9 is pivotable relative to the backrest 5 and the leg rest 8 about sixth and seventh axes (F, G), respectively.

It is noted that the first, second, third, fourth, fifth, sixth, and seventh axes (A, B, C, D, E, F, G) are parallel to each other.

From the above description, the backrest 5 is pivotable relative to the support frame 2 to a seating position. At this position, as best shown in 2, the backrest 5 and the seat member 7 cooperatively define a first angle (α) therebetween, and the seat member 7 and the leg rest 8 cooperatively define a second angle (β) therebetween. Furthermore, the backrest 5 is pivotable relative to the support frame 2 to a reclining position. At this position, as best shown in FIG. 3, the first and second angles (α, β) are widened.

In use, when the backrest 5 is in the seating position and when it is desired to move the backrest 5 to the reclining position, the first end portion 51 of the backrest 5 is pivoted downwardly relative to the support frame 2, as indicated by the arrow (X). This pivotal movement, through appropriate manual force, results in concurrent upward sliding movement of the seat member 7 relative to the support frame 2, as indicated by the arrow (Y) , and upward pivoting movement of the leg rest 8 relative to the support frame 2, as indicated by the arrow (Z) . At this time, when it is desired to move the backrest 5 back to the seating position, the first end portion 51 of the backrest 5 is pivoted upwardly relative to the support frame 2, as indicated by the arrow (U). This pivotal movement, through appropriate manual force, results in concurrent downward sliding movement of the seat member 7 relative to the support frame 2, as indicated by the arrow (V), and downward pivoting movement of the leg rest 8 relative to the support frame 2, as indicated by the arrow (W).

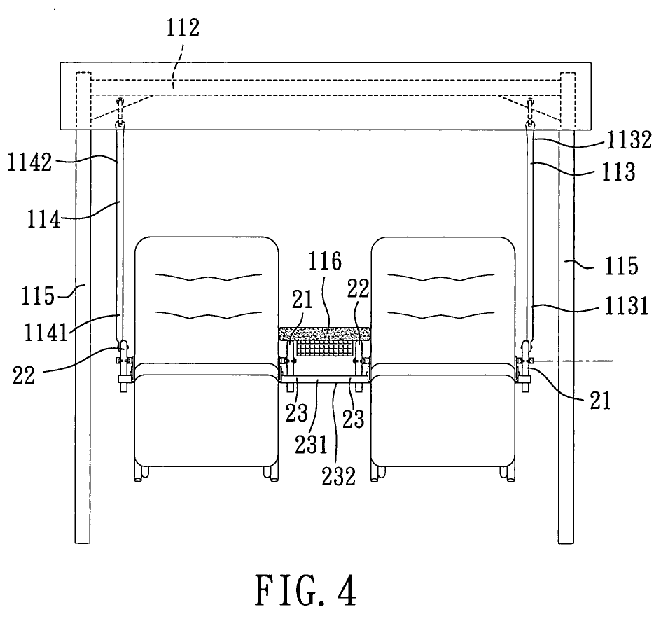

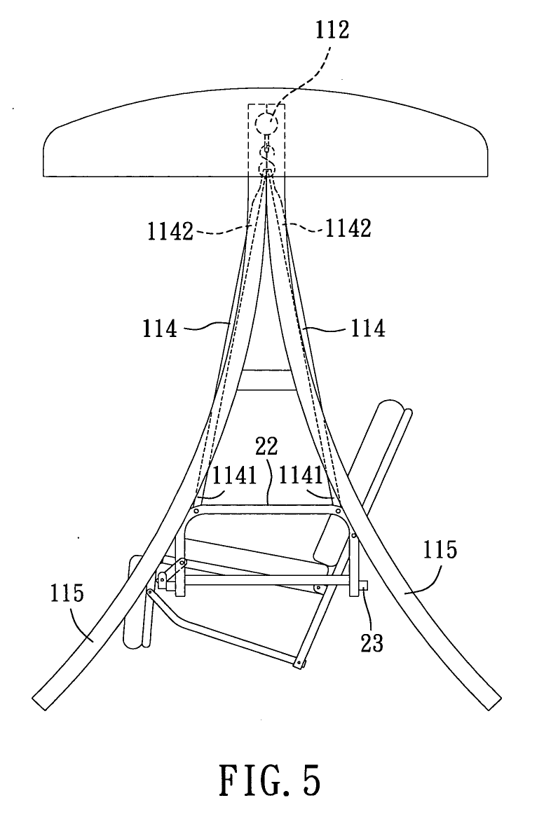

In an application of the chair of this invention, as illustrated in FIGS. 4 and 5, two of the chairs are coupled together by connecting the second end portion 232 of the first horizontal bar 23 of one of the chair to the first end portion 231 of the second horizontal bar 23 of the other chair. The chairs are suspended by means of first and second support members 113, 114 to a crossbar 112 that is supported by a pair of upright posts 115. In particular, each of the first and second support members 113, 114 is generally inverted V-shaped, and includes a pair of legs, each of which has opposite first and second end portions 1131, 1141, 1132, 1142. The first end portion 1131 of the legs of the first support member 113 is connected to the armrest 21 of one of the chair, whereas the second end portion 1132 of the legs of the first support member 113 is connected pivotally to the crossbar 112. Similarly, the first end portion 1141 of the legs of the second support member 114 is connected to the armrest 22 of the other chair, whereas the second end portion 1142 of the legs of the second support member 114 is connected pivotally to the crossbar 112. The construction as such permits the chairs to swing back and forth. In addition, a flat board 116, which serves as a coffee table, is disposed between and has opposite ends mounted on the armrest 21, 22 of the chairs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A chair comprising:
a support frame;
a backrest having opposite first and second end portions, and a middle portion disposed between said first and second end portions of said backrest and coupled pivotally to said support frame;
a seat member having opposite first and second ends, said first end of said seat member being coupled pivotally to said backrest at a position between said middle portion and said second end portion of said backrest;
a connecting unit having a first pivot end coupled pivotally to said seat member at a position between said first and second ends of said seat member, and a second pivot end opposite to said first pivot end of said connecting unit and coupled pivotally to said support frame;
a leg rest having opposite first and second ends, said first end of said leg rest being coupled pivotally to said second end of said seat member; and
a coupling unit having a first pivot end coupled pivotally to said second end portion of said backrest, and a second pivot end opposite to said first pivot end of said coupling unit and coupled pivotally to said leg rest at a position between said first and second ends of said leg rest,
wherein said backrest is pivotable relative to said support frame from a seating position, where said backrest and said seat member cooperatively define a first angle therebetween and where said seat member and said leg rest cooperatively define a second angle therebetween, to a reclining position, where said first and second angles are widened.

2. The chair as claimed in claim 1, wherein said backrest is pivotable relative to said support frame about a first axis, said seat member is pivotable relative to said backrest about a second axis, said connecting unit is pivotable relative to said support frame and said seat member about third and fourth axes, respectively, said leg rest is pivotable relative to said seat member about a third axis, and said coupling unit is pivotable relative to said backrest and said leg rest about fourth and fifth axes, respectively,
the first, second, third, fourth, fifth, sixth, and seventh axes being parallel to each other.

3. The chair as claimed in claim 1, wherein said support frame includes a bracket mounted on said support frame, said second pivot end of said connecting unit being coupled pivotally to said bracket.

4. The chair as claimed in claim 4, wherein said bracket is generally U-shaped.

5. The chair as claimed in claim 1, wherein said connecting unit is generally U-shaped.
